(19) United States
(12) Patent Application Publication
(10) Pub. No.: US 2004/0124028 A1
(43) Pub. Date: Jul. 1, 2004

(54) Convection cooled radiator for an all terrain vehicle

(76) Inventors: Daniel Lachapelle, Sherbrooke (CA); Roger Rioux, Magog (CA)

Correspondence Address: PILLSBURY WINTHROP, LLP, P.O. BOX 10500, MCLEAN, VA, 22102, US

(21) Appl. No.: 10/655,597

(22) Filed: Sep. 5, 2003

Related U.S. Application Data
(60) Provisional application No. 60/407,939, filed on Sep. 5, 2002.

(51) Int. Cl. B60K 1/00; B60K 8/00

(52) U.S. Cl. 180/291

(57) ABSTRACT

A straddle-type vehicle includes a frame supporting front and rear wheels, a seat supported above the frame, an engine supported by the frame below the seat to supply power to at least one of the front and rear wheels, and a coolant system having a radiator mounted to the frame and communicated with the engine to cool coolant circulating through coolant passages provided in the engine. The radiator is mounted to the frame such that the radiator is disposed at an angle with respect to a vertical axis of the frame such that an upper end of the radiator is located closer to a front portion of the vehicle than a lower end of the radiator.

### CROSS-REFERENCE TO RELATED APPLICATIONS

This application claims the benefit of priority to U.S. Provisional Application No. 60/407,939, titled “COOLANT SYSTEM FOR AN ALL TERRAIN VEHICLE,” filed Sep. 5, 2002, which is incorporated by reference herein in its entirety.

### BACKGROUND OF THE INVENTION

1. Field of the Invention

The present invention relates to an improved straddle-type all terrain vehicle (ATV), and more particularly to the structure, placement, and orientation of a radiator of a coolant system within the ATV.

2. Description of Related Art

Radiators for ATVs are typically mounted on the front of the engine frame, parallel to the vertical axis of the ATV, so that heat from the engine can be dissipated to air passing thereby. Specifically, radiators form part of a closed loop coolant system of the ATV. The coolant system of the ATV requires a steady flow of coolant in order to remove excess heat from the engine.

As would be appreciated by those skilled in the art, a coolant pump circulates the coolant through a cooling jacket surrounding the piston cylinder(s) of the engine to absorb heat from the engine. Coolant from the coolant jacket is then directed, via flexible hoses or rigid piping, to the radiator where the heat is dissipated to the passing air. Typically, a fan, operatively driven by either an electric motor or the output shaft of the engine, is positioned and configured to facilitate movement of air through the radiator such that heat is removed from the system. The coolant cooled by the radiator is then returned to the coolant pump, via flexible hoses or rigid piping, and circulated back through the coolant jacket to repeat the cycle.

It is also known to mount the radiator of a coolant system on a rear portion of the engine frame. For example, U.S. Pat. No. 6,523,634 discloses a straddle-type vehicle having a radiator located behind the engine at the rear area of the frame. The radiator is inclined with respect to a vertical axis of the frame such that a lower end of the radiator is located closer to a front portion of the vehicle than an upper end of the radiator. Forward facing ventilation openings are provided in the rear fenders of the vehicle so that air may be directed to the radiator. A cooling fan is mounted in a conventional manner within a shroud mounted onto the radiator.

There is always a need in the vehicle art to reduce vehicle costs and vehicle weight. The present invention addresses these needs in the art, as well as other needs, by modifying the conventional coolant system for an ATV.

### SUMMARY OF THE INVENTION

It is one aspect of the present invention to provide an improved coolant system that eliminates the need for a fan.

It is another aspect of the present invention to provide a coolant system having a radiator that is configured and positioned to provide increased cooling efficiency and effectiveness relative to conventional radiators.

According to one aspect of the present invention, a straddle-type vehicle includes a frame supporting front and rear wheels, a seat supported above the frame, an engine supported by the frame below the seat to supply power to at least one of the front and rear wheels. The vehicle has a coolant system with a radiator mounted to the frame and is fluidly coupled to the engine to cool coolant circulating through coolant passages provided in the engine. The radiator is mounted to the frame such that the radiator is disposed at an angle with respect to a vertical axis of the frame such that an upper end of the radiator is located closer to a front portion of the vehicle than a lower end of the radiator.

A further aspect of the present invention provides an ATV with a frame supporting front and rear wheels, a seat on the frame, and an engine supported by the frame to supply power to at least one of the front and rear wheels. The ATV has a coolant system with a radiator mounted to a front portion of the frame and fluidly coupled to the engine to cool coolant circulating through the engine. The radiator is mounted to the front portion of the frame at an angle with respect to a vertical axis of the frame such that an upper end of the radiator is located closer to a front portion of the vehicle than a lower end of the radiator.

Other aspects, features and advantages of this invention will become apparent from the following detailed description when taken in conjunction with the accompanying drawings, which are a part of this disclosure, and which illustrate, by way of example, the principles of this invention.

### BRIEF DESCRIPTION OF THE DRAWINGS

The accompanying drawings facilitate an understanding of the various embodiments of this invention. In the drawings:

FIG. 1 is a perspective view of an all terrain vehicle according to one embodiment of the invention;

FIG. 2 is perspective view of a front portion of the all terrain vehicle shown in FIG. 1 with a coolant system attached to a frame of the all terrain vehicle according to one embodiment of the invention;

FIG. 3 is an exploded view of the coolant system attached to the frame of the all terrain vehicle shown in FIG. 1;

FIG. 4 is an enlarged view of the radiator of the coolant system showing one example of attachment to an upper frame member of the all terrain vehicle shown in FIG. 1;

FIG. 5 is a right side view of the radiator of the coolant system showing one example of attachment to the frame of the all terrain vehicle shown in FIG. 1;

FIG. 6 is a left side view of the radiator of the coolant system showing one example of attachment to the frame of the all terrain vehicle shown in FIG. 1;

FIG. 7 is an enlarged view of the radiator of the coolant system showing one example of attachment to a lower frame member of the all terrain vehicle shown in FIG. 1;

FIG. 8 is front view of the all terrain vehicle shown in FIG. 1;

FIG. 9 is a front left perspective view of the frame of the all terrain vehicle shown in FIG. 1;

FIG. 10 is a right perspective view of the frame of the all terrain vehicle shown in FIG. 1; and

FIG. 11 is an enlarged view of the radiator of the coolant system showing its attachment to the lower frame member of the all terrain vehicle shown in FIG. 1.

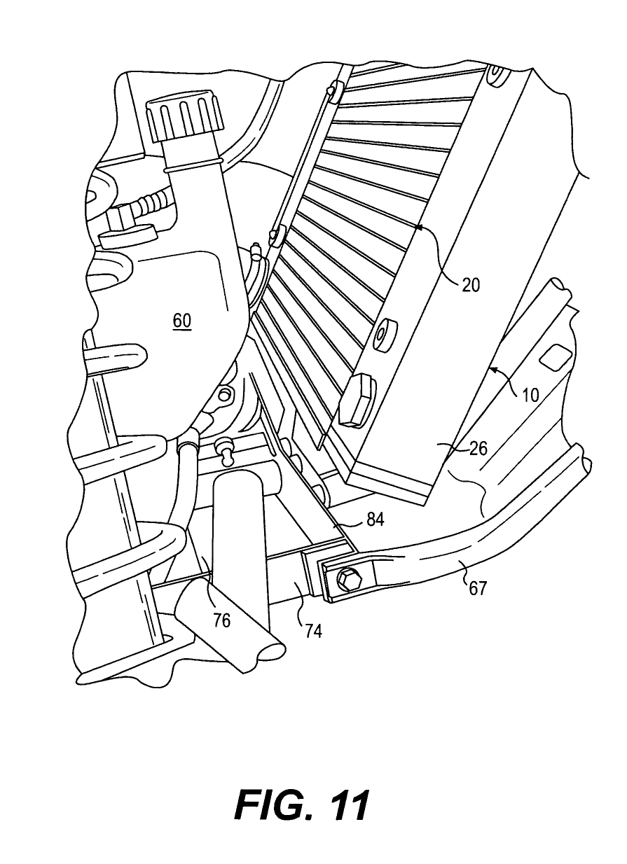

### DETAILED DESCRIPTION OF ILLUSTRATED EMBODIMENTS

For convenience of the reader, the directions “up”, “down”, “right”, and “left” are defined according to the normal travel direction of the vehicle, as observed by a rider on the vehicle.

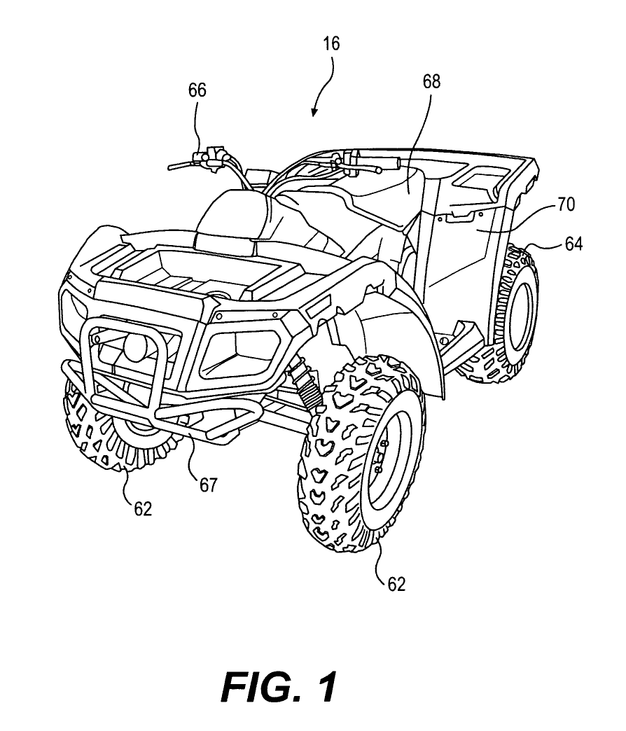

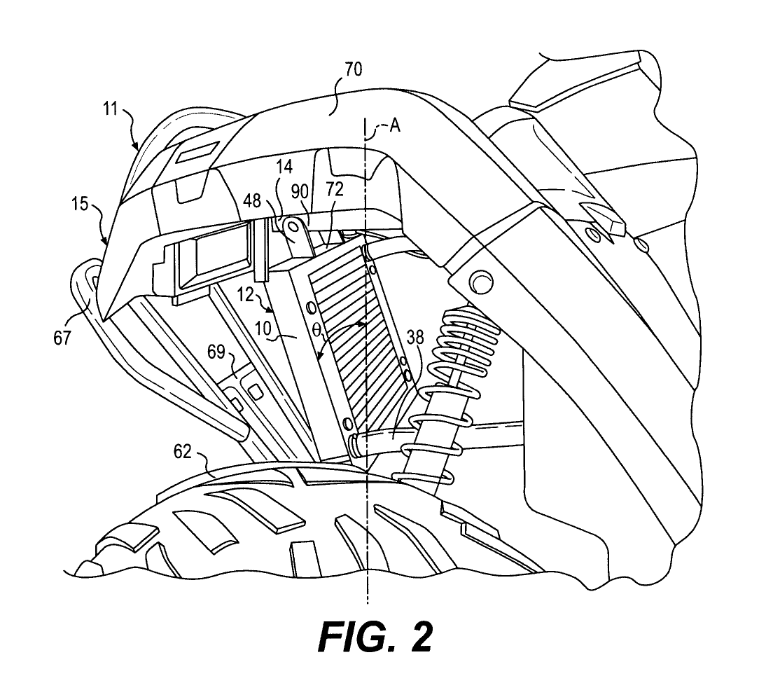

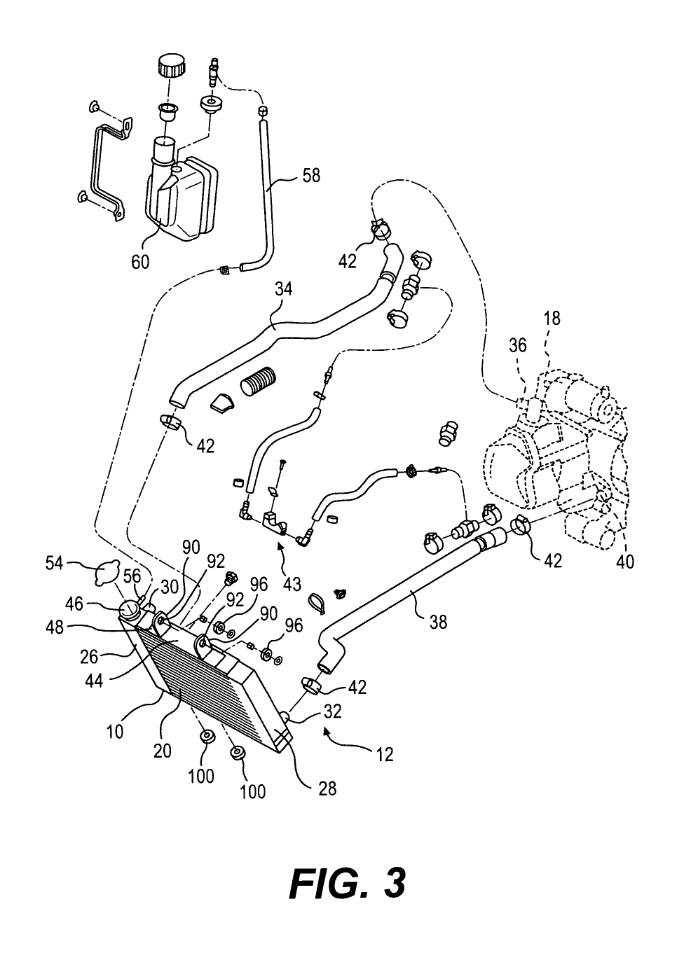

FIG. 1 shows an ATV 16 structured according to one embodiment of the present invention. The ATV 16 includes front wheels 62 and rear wheels 64 suspended on a front end and on a rear end, respectively, of a frame 14 (see FIGS. 2, 9, and 10). Handlebars 66, a straddle-type seat 68, and a body 70 are mounted on the frame 14. An internal combustion engine 18 (see FIG. 3) is mounted on the frame 14 below the seat 68 to generate power to at least one of the front and rear wheels 62, 64 for propelling the ATV 16.

As would be appreciated by those skilled in the art, the handlebars 66 are disposed in front of the straddle-type seat 68. The handlebars 66 are operatively connected to at least one of the front or rear wheels 62, 64 to steer the ATV 16. The straddle-type seat 68 accommodates a driver, as well as any passengers, of the ATV 16 in a straddle fashion, as the name suggests. When seated on the straddle-type seat 68, the driver, for example, will have his legs positioned on either side thereof.

The body 70 of the ATV 16 may be designed with any visual characteristics desirable for the vehicle. The body 70 may not only be provided with ornamental features, it may also be designed with some functional characteristics, such as storage compartments and the like.

The engine 18 may be of any type as would be appreciated by those skilled in the art. For example, the engine 18 may be a multiple cylinder, in-line, V-type, or opposed cylinder engine. While a four-stroke internal combustion engine is preferred, the engine 18 may also be a two-stroke internal combustion engine, as would be appreciated by those skilled in the art. Alternatively, the engine 18 need not be an internal combustion engine. Instead, an electric motor powered by batteries or a fuel cell may be used without departing from the scope of the invention.

FIG. 2 illustrates a radiator 10 of a coolant system 12 attached to the frame 14 of the ATV 16 according to one embodiment of the present invention. The radiator 10 is mounted to the frame 14 at a front portion 15 of the ATV 16 to allow the radiator 10 to dissipate engine heat to air flowing thereby and therethrough. As illustrated, the radiator 10 is disposed at an angle θ with respect to a vertical axis A of the ATV 16, and, hence, the frame 14. Mounting the radiator 10 at an angle θ with respect to the vertical axis A of the ATV 16 increases the cooling efficiency and effectiveness of the radiator 10 with respect to conventional radiators that are mounted parallel to the vertical axis of the ATV, as will be discussed below. Further, while the coolant system 12 and radiator 10 have been specifically structured for use with an ATV, as illustrated, the coolant system 12 and radiator 10 may be suitably structured for use with other suitable vehicle types, including but not limited to snowmobiles, personal watercraft, three-wheeled vehicles, and the like.

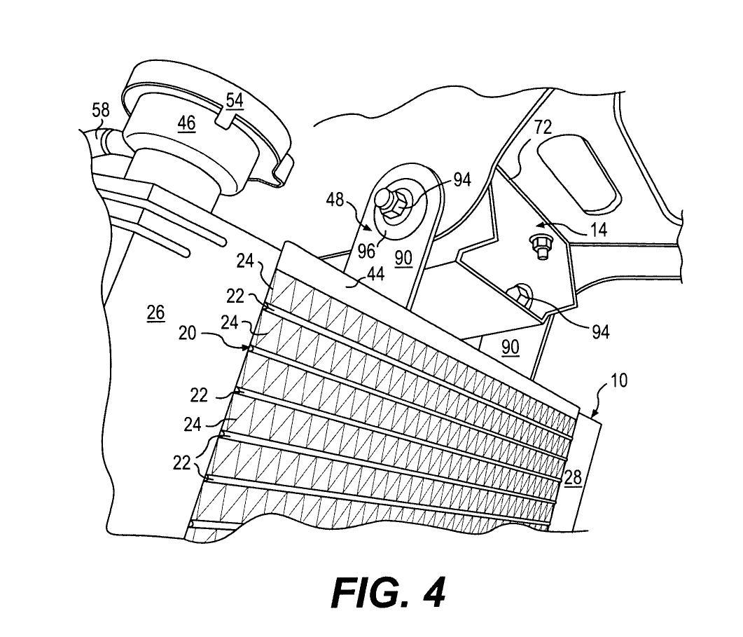

FIG. 3 is an exploded view of the coolant system 12. The radiator 10 of the coolant system 12 is structured to permit liquid cooling of the engine 18 of the ATV 16. As best shown in FIG. 4, the radiator 10 has a core 20 formed of a plurality of spaced-apart plate pairs 22 with cooling fins 24 located therebetween. The plate pairs 22 are spaced apart to provide air flow passages between the plate pairs 22 where the cooling fins 24 are located. The space between the cooling fins 24 of the radiator 10 are enlarged (e.g., 12 fins per inch) with respect to conventional radiators. This allows easier cleaning and results in a construction that retains less debris, a feature particularly useful on an ATV, where debris (i.e., dirt, mud, etc.) is expected to accumulate during operation of the vehicle.

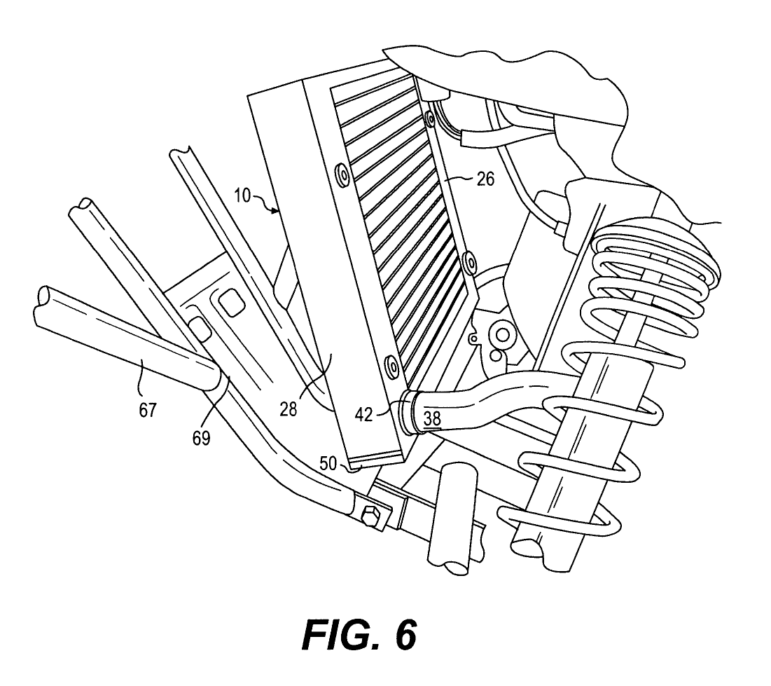

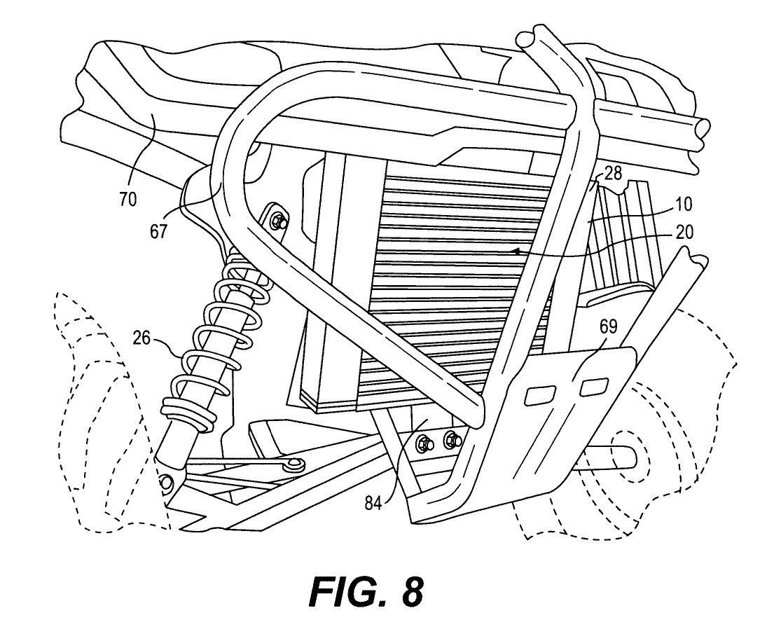

As shown in FIGS. 1, 2, and 8, a front bumper 67 is mounted to the frame 14 and includes an opening to permit the flow of air to the radiator 10. The lower portion of the front bumper 67 includes a cover 69 (see FIGS. 2 and 6) to prevent rocks, branches, and other debris from contacting and damaging the radiator 10. However, the radiator 10 is structured such that the plate pairs 22 extend further outwardly from the radiator 10 than the cooling fins 24 (see FIG. 4). This structure protects the cooling fins 24 against impacts from rocks, branches, and other debris, which helps to maintain the cooling efficiency of the radiator 10. Thus, in another embodiment, the ATV 16 may not provide a front bumper 67 due to the protective radiator structure. Without a front bumper 67, the cost and weight of the ATV 16 may be further reduced.

The radiator 10 has a pair of manifolds 26, 28 (see FIGS. 3 and 4) located at the respective ends of plate pairs 22. As shown in FIG. 3, an inlet fitting 30 is provided on the manifold 26 for allowing the flow of coolant into the radiator 10 and an outlet fitting 32 is provided on the other manifold 28 for allowing the flow of coolant out of the radiator 10.

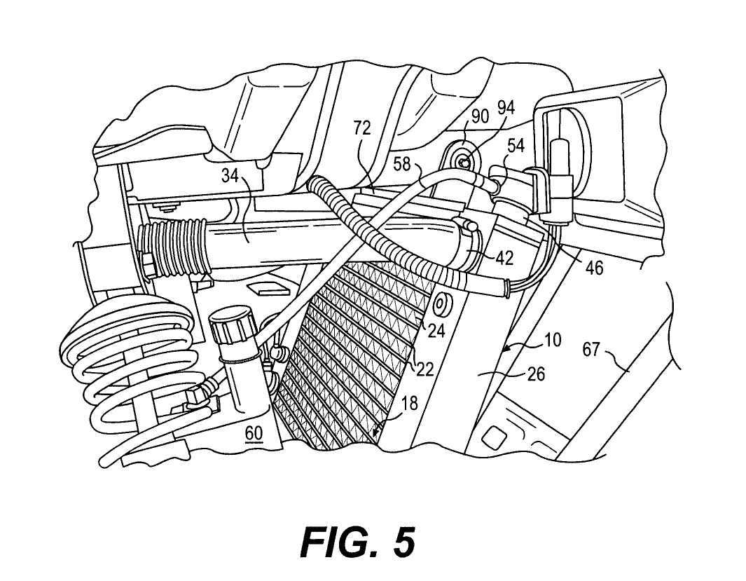

As shown in FIGS. 3 and 5, an inlet hose 34 has one end connected to the inlet fitting 30 of the radiator 10 and an opposite end connected to a fitting 36 provided on the engine 18 to enable coolant from the engine 18 to enter the radiator 10. As shown in FIGS. 3 and 6, an outlet hose 38 has one end connected to the outlet fitting 32 of the radiator 10 and an opposite end connected to a fitting 40 associated with a coolant pump to enable coolant to exit the radiator 10 and enter the coolant pump. The coolant pump circulates the coolant through the cooling jacket surrounding the engine 18. It also circulates coolant to and from the radiator 10. Hose clamps 42 hold the inlet and outlet hoses 34, 38 on the respective fittings 30, 32, 36, 40. A carburetor heater assembly 43 may extend between the inlet hose 34 and the outlet hose 38 for heating a carburetor associated with the engine 18.

In operation, coolant is drawn into the interior of the radiator 10 via the inlet hose 34. The coolant passes through the interior of the radiator 10, via passages within the plate pairs 22, and exits via the outlet hose 38 that is associated with the coolant pump. However, different configurations are possible for the input to and output from the radiator 10 depending on the particular design of the engine 18.

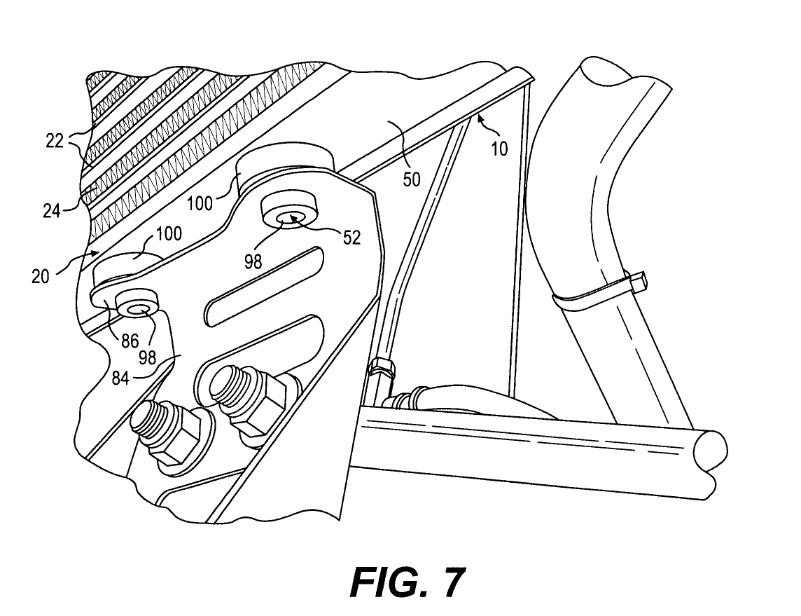

As shown in FIGS. 3 and 4, a top end plate 44 closes the upper ends of the manifolds 26, 28 and provides a filler cap fitting 46 and an upper mounting bracket 48 for mounting the radiator 10 in a desired location. As shown in FIG. 7, a bottom end plate 50 is also provided to close the lower ends of the manifolds 26, 28 and provide a lower mounting bracket 52 for mounting the radiator 10 in a desired location on the vehicle.

As shown in FIGS. 3 and 5, the radiator 10 includes a filler cap 54 removably mounted on the filler cap fitting 46. The filler cap fitting 46 has an overflow or pressure relief outlet 56. A hose 58 extends from the outlet 56 and is connected to a coolant reservoir 60.

In the illustrated embodiment, the radiator 10 has a width in the range of about 340-350 mm, a height in the range of about 250-260 mm, and a thickness in the range of about 40-50 mm. More specifically, the radiator 10 has a width of about 343 mm, a height of about 253 mm, and a thickness of about 42 mm. However, the radiator 10 may have any suitable size depending on the design of the ATV 16 and the cooling requirements thereof.

A further understanding of the operation of the radiator 10 is not necessary in order to understand the principles of the present invention and thus will not be further detailed herein. For example, operational details of the radiator 10 are disclosed in U.S. Pat. Nos. 6,311,768 and 6,332,495, the entireties of both being incorporated by reference into the present specification.

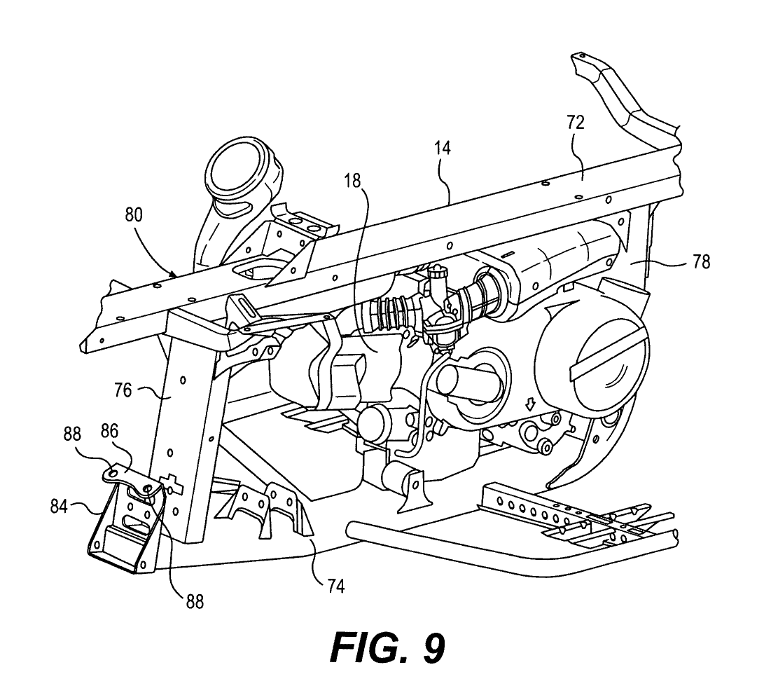

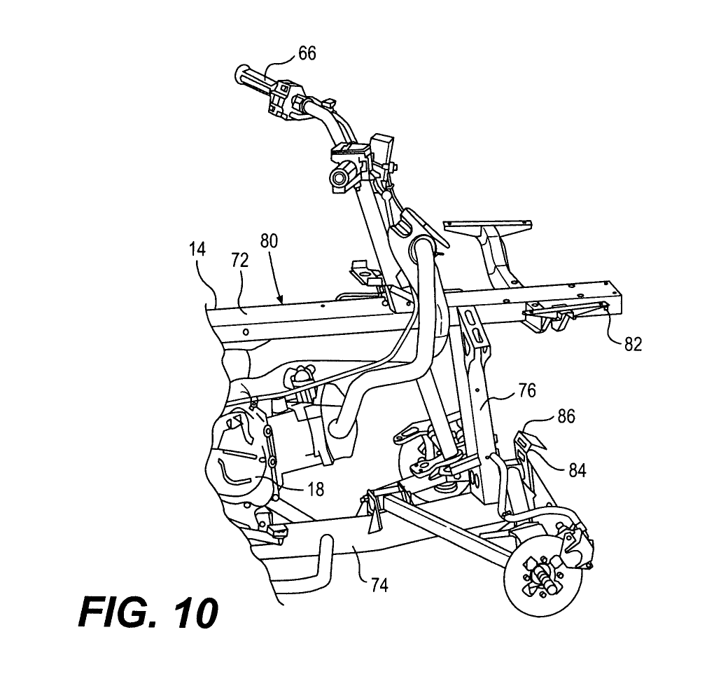

As shown in FIGS. 9 and 10 (the body, forward and rearward wheel assemblies, and suspension system of the ATV 16 have been removed for clarity), the frame 14 of the ATV 16 includes an upper frame member 72 and a lower frame member 74. The upper and lower frame members 72, 74 are connected by forward and rearward cross members 76, 78. The upper and lower members 72, 74, and the forward and rearward cross members 76, 78 are configured to form a rigid truss structure, or support module 80. The support module 80 is defined on upper and lower sides thereof by the upper member 72 and the lower member 74, respectively. Further, the support module 80 is defined on forward and rearward sides thereof by the forward and rearward cross members 76, 78, respectively. A central opening of the support module 80 is provided by inner peripheries of the members 72, 74, 76, 78 and defines an engine receiving space. The internal combustion engine 18 is securely mounted to the support module 80 within the engine receiving space.

As best shown in FIG. 10, the upper frame member 72 extends further outwardly from the forward cross member 76 than the lower frame member 74. The upper frame member 72 includes openings 82 through opposing side walls. Further, the lower frame member 74 includes a bracket 84 rigidly mounted thereto by welding, for example. As best shown in FIG. 9, the bracket 84 is bent to provide an inclined portion 86 that provides a mounting platform for the radiator 10. The inclined portion 86 includes a pair of openings 88 therethrough. This configuration enables the radiator 10 to be mounted between the upper and lower frame members 72, 74 at an angle θ with respect to the vertical axis A of the ATV 16, as will be further discussed.

In the illustrated embodiment, the upper mounting bracket 48 of the radiator 10 includes a pair of parallel tabs 90 that extend outwardly from the top end plate 44, as shown in FIGS. 3 and 4. The tabs 90 may be integrally formed with the top end plate 44 or may be separately formed and attached thereto via welding or other suitable techniques as would be appreciated by those skilled in the art. Each tab 90 has an opening 92 therethrough. The tabs 90 are spaced so as to receive the upper frame member 72 therebetween with the openings 82, 90 aligned so as to receive a fastener 94 (see FIG. 4) therethrough. In the illustrated embodiment, the fastener 94 is a nut and bolt that securely fastens the upper mounting bracket 48 to the upper frame member 72. Further, an elastomeric member such as a grommet 96 is positioned between each opening 92 and the bolt to reduce the transmission of engine vibration to the radiator 10 or to the support module 80. Alternatively, the tabs 90 may be mounted to the upper frame member 72 by welding or by any other suitable manner. Moreover, the radiator 10 may have any suitable structure or mounting bracket that enables the upper end of the radiator 10 to be mounted to the upper frame member 72.

In the illustrated embodiment, the lower mounting bracket 52 (see FIG. 7) of the radiator 10 is in the form of a pair of parallel post members 98 that extend outwardly from the bottom end plate 50, as shown in FIG. 7. The post members 98 may be integrally formed with the bottom end plate 50 or may be manufactured separately and attached to the bottom end plate 50. The post members 98 are spaced so as to be aligned with and inserted through the openings 88 (see FIG. 9) in the bracket 84 provided on the lower frame member 74. Further, an elastomeric member such as a grommet 100 (see FIG. 7) is positioned about each of the post members 98 between the bracket 84 and the bottom end plate 50 to reduce the transmission of engine vibration to the radiator 10 or from the radiator 10 to the support module 80. Alternatively, the bottom end plate 50 may be mounted to the bracket 84 by fasteners or in any other suitable manner. Moreover, the radiator 10 may have any suitable structure or mounting bracket that enables the lower end of the radiator 10 to be mounted to the lower frame member 74.

In the illustrated embodiment, the radiator 10 may be mounted to the frame 14 by first inserting the post members 98 of the bottom end plate 50 through the openings 88 in the bracket 84 and then aligning the openings 92 of the tabs 90 with the openings 82 in the upper frame member 72 to allow insertion of the fasteners 94 therethrough.

When mounted, the radiator 10 is disposed at an angle θ with respect to the vertical axis A of the ATV 16 as shown in FIG. 2. Specifically, the upper end of the radiator 10 is located closer to the front portion 15 of the ATV 16 than the lower end of the radiator 10. The radiator 10 is disposed at an angle θ in the range of about 25-30° with respect to the vertical axis A of the ATV 16. In the illustrated embodiment, the radiator is disposed at an angle θ of about 28° with respect to the vertical axis A of the ATV 16. However, the radiator 10 may be disposed at any angle θ greater than about 0° but less than about 45° with respect to the vertical axis A of the ATV 16. The angle of the inclined portion 86 of the bracket 84 (see FIG. 9) determines the angle θ of the radiator 10 and may be adjusted to adjust the angle θ of the radiator 10 with respect to the vertical axis A of the ATV 16.

Mounting the radiator 10 at an angle θ with respect to the vertical axis A of the ATV 16 increases the cooling efficiency and effectiveness of the radiator 10 with respect to conventional radiators that are mounted parallel to the vertical axis of the ATV. The angling of the radiator 10 enables the radiator 10 to release more heat by natural convection. Specifically, mounting the radiator 10 at an angle θ alters the angle of the plate pairs 22 and cooling fins 24 with respect to the vertical axis A of the ATV 16. The convection currents associated with the plate pairs 22 and cooling fins 24 are influenced by this inclination. More specifically, the heated, lighter air adjacent the plate pairs 22 and cooling fins 24 tends to rise vertically. Because of the inclination, the motion of the heated, lighter air is less hindered by the heavier, cooler air surrounding it which facilitates the transfer of heat from the plate pairs 22 and cooling fins 24 to the cooler surrounding air. Moreover, the motion of the heated air is less hindered by adjacent plate pairs 22 and cooling fins 24 such that the heat from the plate pairs 22 and cooling fins 24 is directly transferred to the cooler surrounding air.

Further, the radiator 10 is angled such that heated air rising vertically away from the plate pairs 22 and cooling fins 24 is carried away from the radiator 10 by the movement of air passing thereby during operation of the ATV 16.

Because of the increased cooling efficiency of the radiator 10, the coolant system 12 does not require a fan. Specifically, the cooling capacity of the angled radiator 10 is substantially similar to or superior than the cooling capacity of a conventional radiator that is mounted parallel to the vertical axis of the ATV and includes a fan. Without a fan mounted to the ATV 16, the cost and weight of the ATV 16 can be reduced. However, a fan may be provided if further cooling efficiency is required.

It is noted that the improved effectiveness of the radiator 10 is appreciated when the ATV 16 is moving forwardly, rearwardly, or when the vehicle is stationary. As discussed, the angular inclination of the radiator 10 facilitates cooling by establishing convective cooling as a result of hot air rising vertically therefrom. Therefore, convective air flow generated by the ATV 16 upon forward movement is not needed for the radiator 10 to cool the coolant flowing therein.

In another embodiment contemplated by the invention, the radiator 10 may be mounted at a rear portion of the ATV 16. Specifically, the radiator 10 may be mounted at a rear portion of the ATV 16 such that the upper end of the radiator 10 is located closer to the front portion 15 of the ATV 16 than the lower end of the radiator 10. The radiator 10 may be disposed at any angle θ greater than about 0° but less than about 45° with respect to the vertical axis A of the ATV 16. Ventilation openings may be defined in the rear fenders of the ATV 16 for conveying air to the radiator 10.

It can thus be appreciated that the aspects of the present invention have been fully and effectively accomplished. The foregoing specific embodiments have been provided to illustrate the structural and functional principles of the present invention, and are not intended to be limiting. To the contrary, the present invention is intended to encompass all modifications, alterations, and substitutions within the spirit and scope of the disclosed embodiments.

What is claimed is:

1. A straddle-type vehicle, comprising:
a frame supporting front and rear wheels;
a seat on the frame;
an engine supported by the frame to supply power to at least one of the front and rear wheels; and
a coolant system having a radiator mounted to the frame and fluidly coupled to the engine, wherein the radiator cools coolant circulating through the engine, the radiator being mounted to the frame at an angle with respect to a vertical axis of the frame such that an upper end of the radiator is located closer to a front portion of the vehicle than a lower end of the radiator.

2. A straddle-type vehicle according to claim 1, wherein the angle is greater than about 0° and less than about 45° with respect to the vertical axis of the frame.

3. A straddle-type vehicle according to claim 2, wherein the angle is in the range of about 25-30° with respect to the vertical axis of the frame.

4. A straddle-type vehicle according to claim 3, wherein the angle is about 28° with respect to the vertical axis of the frame.

5. A straddle-type vehicle according to claim 1, wherein the radiator is mounted to a front portion of the frame.

6. A straddle-type vehicle according to claim 5, wherein the frame includes an upper frame member, a lower frame member, and forward and rearward cross members connected between the upper and lower frame members, the upper frame member extending further outwardly from the forward cross member than the lower frame member to enable the radiator to be disposed at an angle with respect to the vertical axis of the frame.

7. A straddle-type vehicle according to claim 6, wherein the lower frame member includes a bracket mounted thereto that provides an inclined portion having an angle that determines the angle of the radiator, the radiator being mounted to the frame such that the lower end of the radiator is mounted to the inclined portion of the bracket and the upper end of the radiator is mounted the upper frame member.

8. A straddle-type vehicle according to claim 7, wherein the lower end of the radiator includes a pair of post members that are inserted into corresponding openings provided in the inclined portion of the bracket and wherein the upper end of the radiator includes a pair of tabs that securely receive the upper frame member therebetween.

9. A straddle-type vehicle according to claim 1, wherein the radiator operates without assistance from a fan.

10. A straddle-type vehicle according to claim 1, wherein the straddle-type vehicle is an all terrain vehicle.

11. A straddle-type vehicle according to claim 1, wherein the straddle-type vehicle is a snowmobile.

12. An all terrain vehicle, comprising:
a frame supporting front and rear wheels;
a seat on the frame;
an engine supported by the frame to supply power to at least one of the front and rear wheels; and
a coolant system having a radiator mounted to a front portion of the frame, the radiator being fluidly coupled to the engine to cool coolant circulating therethrough, the radiator being mounted to the front portion of the frame at an angle with respect to a vertical axis of the frame such that an upper end of the radiator is located closer to a front portion of the vehicle than a lower end of the radiator.

13. An all terrain vehicle according to claim 12, wherein the angle is greater than about 0° and less than about 45° with respect to the vertical axis of the frame.

14. An all terrain vehicle according to claim 13, wherein the angle is in the range of about 25-30° with respect to the vertical axis of the frame.

15. An all terrain vehicle according to claim 14, wherein the angle is about 28° with respect to the vertical axis of the frame.

16. An all terrain vehicle according to claim 12, wherein the frame includes an upper frame member, a lower frame member, and forward and rearward cross members connected between the upper and lower frame members, the upper frame member extending further outwardly from the forward cross member than the lower frame member to enable the radiator to be disposed at an angle with respect to the vertical axis of the frame.

17. An all terrain vehicle according to claim 16, wherein the lower frame member includes a bracket mounted thereto that provides an inclined portion having an angle that determines the angle of the radiator, the radiator being mounted to the frame such that the lower end of the radiator is mounted to the inclined portion of the bracket and the upper end of the radiator is mounted the upper frame member.

18. An all terrain vehicle according to claim 17, wherein the lower end of the radiator includes a pair of post members that are inserted into corresponding openings provided in the inclined portion of the bracket and wherein the upper end of the radiator includes a pair of tabs that securely receive the upper frame member therebetween.

19. An all terrain vehicle according to claim 12, wherein the radiator operates without assistance from a fan.
